(19) United States
(12) Patent Application Publication
(10) Pub. No.: US 2016/0055495 A1
(43) Pub. Date: Feb. 25, 2016

(54) SYSTEMS AND METHODS FOR ESTIMATING DEMAND

(71) Applicant: Wal-Mart Stores, Inc., Bentonville, AR (US)

(72) Inventors: Zhiwei Qin, San Mateo, CA (US); John Bowman, El Cerrito, CA (US); Jagtej Bewli, San Mateo, CA (US)

(21) Appl. No.: 14/466,239

(22) Filed: Aug. 22, 2014

(51) Int. Cl. G06Q 30/02

(52) U.S. Cl. CPC G06Q 30/0202

(57) ABSTRACT

A method for computing a demand probability for one or more products. The method can include establishing one or more similarities between one or more regional segments and combining the one or more regional segments into one or more clusters based on the one or more similarities. The method can also include executing one or more computer instructions on one or more processors for determining a demand probability distribution across the one or more clusters for the one or more products based on historical data and delivering the one or more products to the one or more clusters based on the demand probability distribution.

### TECHNICAL FIELD

This disclosure relates generally to product distribution systems, and relates more particularly to estimating product demand in a supply chain network.

### BACKGROUND

Online retail has become mainstream, which has allowed customers to order an increasing number of products online and receive direct shipments of the items they order. These products are shipped from supply chain channels, which are sources, distribution centers, or warehouses containing sets of items. Online retailers generally have a network of channels to fulfill orders. A supply chain network is a collection of channels having a fulfillment mechanism. An estimation of demand and/or an estimation of demand distribution for products in a catalog can be a guiding analytic for inventory allocation in any retailer's supply chain operations.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of an exemplary online retail system, portions of which can be employed for estimating demand, according to an embodiment;

FIG. 4 illustrates the within-cluster errors plotted against the number of clusters or demand zones, according to an embodiment;

FIG. 5 illustrates a population distribution over clusters or demand zones, according to an embodiment;

FIG. 6 Illustrates the log-likelihoods of the test data, according to an embodiment;

FIG. 7 illustrates a log likelihood comparison of the demand probability distribution with two benchmarks, according to an embodiment;

FIG. 8 illustrates a mean absolute error (MAE) of the comparisons according to the embodiment of FIG. 7;

FIG. 9 illustrates a flow chart for an exemplary method of estimating demand according to an embodiment; and

FIG. 10 illustrates a block diagram of an example of a demand estimating system, according to the embodiment of FIG. 3.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments include a method for computing a demand probability for one or more products. In some embodiments, the method can comprise establishing one or more similarities between one or more regional segments and combining the one or more regional segments into one or more clusters based on the one or more similarities. The method can further comprise executing one or more computer instructions on one or more processors for determining a demand probability distribution across the one or more clusters for the one or more products based on historical data and delivering the one or more products to the one or more clusters based at least in part on the demand probability distributions.

Other embodiments include a system for computing a demand probability for one or more products. The system can comprise one or more processing modules and one or more transitory memory storage modules storing computer instructions. The one or more transitory memory storage modules storing computer instructions can be configured to run on the one or more processing modules. The transitory memory storage modules can also be configured to perform acts of establishing one or more similarities between one or more regional segments, combining the one or more regional segments into one or more clusters based on the one or more similarities, and determining a demand probability distribution across the one or more clusters for the one or more products based on historical data.

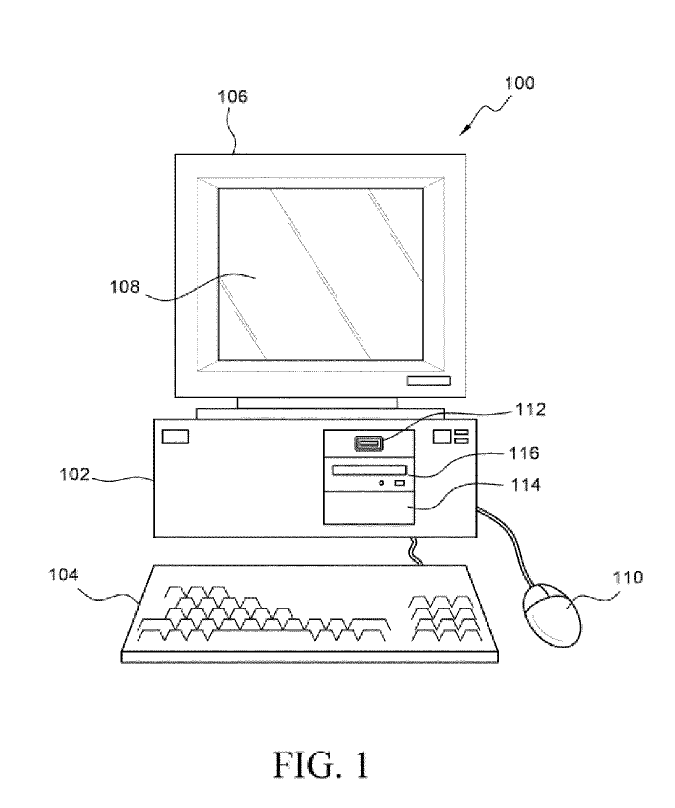

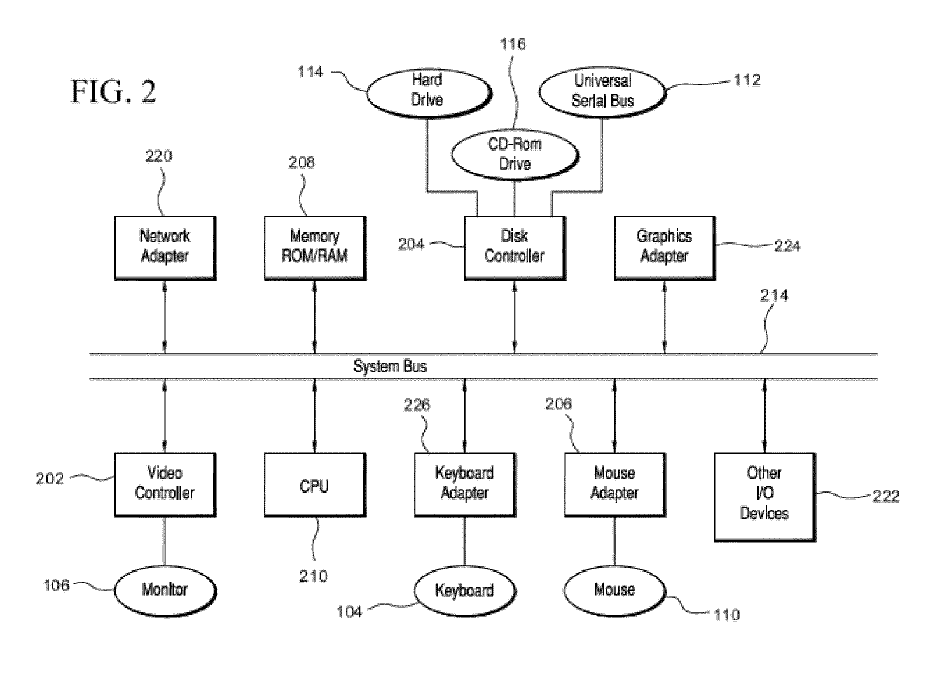

Turning to the drawings, FIG. 1 illustrates an exemplary embodiment of a computer system 100, all of which or a portion of which can be suitable for implementing the techniques described herein. As an example, a different or separate one of a chassis 102 (and its internal components) can be suitable for implementing the techniques described herein. Furthermore, one or more elements of computer system 100 (e.g., a refreshing monitor 106, a keyboard 104, and/or a mouse 110, etc.) can also be appropriate for implementing the techniques described herein. Computer system 100 comprises chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 comprises both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can comprise microcode such as a Basic Input-Output System (BIOS). In some examples, the one or more memory storage units of the various embodiments disclosed herein can comprise memory storage unit 208, a USB-equipped electronic device, such as, an external memory storage unit (not shown) coupled to universal serial bus (USB) port 112 (FIGS. 1-2), hard drive 114 (FIGS. 1-2), and/or CD-ROM or DVD drive 116 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chip set (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 and the circuit boards inside chassis 102 (FIG. 1) are not discussed herein.

When computer system 100 in FIG. 1 is running, program instructions stored on a USB-equipped electronic device connected to USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out at least part of the techniques described herein.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

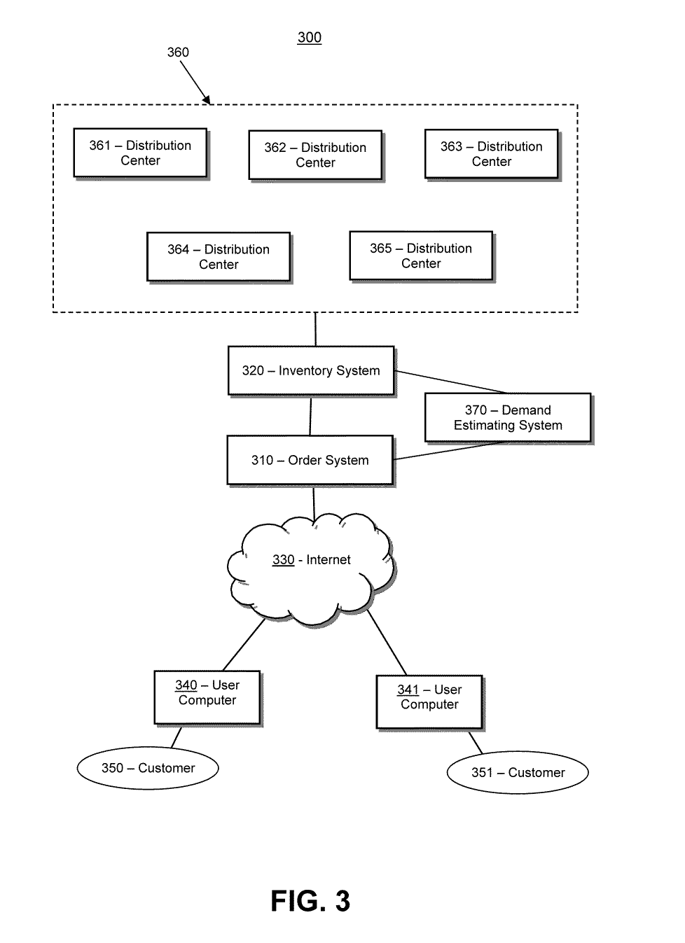

Turning ahead in the drawings, FIG. 3 illustrates a block diagram of an online retail system 300. Online retail system 300 is merely exemplary of a system in which a demand probability for one or more products can be estimated and embodiments of the demand probability system and elements thereof are not limited to the embodiments presented herein. In many embodiments, demand probability can be referred to as demand estimation.

In a number of embodiments, online retail system 300 can include a supply chain network 360. In various embodiments, supply chain network 360 can include one or more channels, such as one or more owned distribution centers (e.g., 361, 362), one or more vendor channels (e.g., 363, 364, 365), and/or other suitable channels, such as stores with order-fulfillment capabilities (not shown). Owned distribution centers (e.g., 361, 362) are owned, operated, and/or controlled by the online retailer. Vendor channels (e.g., 363, 364, 365) are owned, operated, and/or controlled by third-parties, such as drop-ship vendors.

In some embodiments, online retail system 300 can include an order system 310, an inventory system 320, and/or a demand estimating system 370. Inventory system 320, order system 310, and/or demand estimating system 370 can each be a computer system, such as computer system 100 (FIG. 1), as described above, and can each be a single computer, a single server, or a cluster or collection of computers or servers, or a cloud of computers or servers. In another embodiment, all or part of the two or more of inventory system 320, order system 310, and/or demand estimating system 370 can be part of the same single computer, single server, or the same cluster or collection of computers or servers, or the same cloud of computers or servers.

In some embodiments, inventory system 320 can track the items (e.g., stock keeping units (SKUs)) which can be ordered through the online retailer and which can be housed at one or more of the channels (e.g., 361-365) of supply chain network 360. In some embodiments, inventory system 320 can track items for more than one owned distribution center, such as both owned distribution center 361 and owned distribution center 362. In other embodiments, online retail system 300 can include an inventory system (e.g. inventory 320) for each owned distribution center (e.g., 361, 362).

In many embodiments, demand estimating system 370 can be in data communication with inventory system 320 and/or order system 310. In certain embodiments, demand estimating system 370, inventory system 320, and order system 310 can be separate systems. In other embodiments, demand estimating system 370, inventory system 320, and order system 310 can be a single system. In various embodiments, order system 320 can be in data communication through Internet 330 with user computers (e.g., 340, 341). User computers 340-341 can be desktop computers, laptop computers, smart phones, tablet devices, and/or other endpoint devices, which can allow customers (e.g., 350-351) to access order system 320 through Internet 330. In various embodiments, order system 320 can host one or more websites, such as through one or more web servers. For example, order system 320 can host an eCommerce website that can allow customers (e.g., 350, 351) to browse and/or search for products, to add products to an electronic shopping cart, and/or to purchase products by completing an online order, in addition to other suitable activities.

Various embodiments include a method for computing a demand probability for one or more products. In some embodiments, the method can comprise establishing one or more similarities between one or more regional segments and combining the one or more regional segments into one or more clusters based on the one or more similarities. The method can further comprise executing one or more computer instructions on one or more processors for determining a demand probability distribution across the one or more clusters for the one or more products based on historical data and delivering the one or more products to the one or more clusters based on the demand probability distributions.

In some embodiments, the one or more regional segments can be three digit zip codes of the United States (U.S.). The three digit zip codes of the U.S. are the first three digits of the standard five digit zip codes. The first digit of a U.S. zip code generally represents a group of U.S. states. The first 3 digits of a zip code determine the central mail processing facility, also called sectional center facility, that is used to process and sort mail. Currently, there are over 900 three digit zip codes in the U.S. In many embodiments, the shipping costs from the warehouses to neighboring zip codes are similar or the same. Therefore, from an inventory allocation point of view, these clusters or demand zones can be grouped, and the number of clusters can be reduced by aggregating similar zip codes or regional segments.

In a number of embodiments, establishing one or more similarities between one or more regional segments can include representing each of the one or more regional segments by an average shipping cost for each of the one or more products from a location to each of the one or more regional segments and weighting the average shipping cost by a total shipping volume for each of the one or more regional segments. In some embodiments, the average shipping cost for each of the one or more products from the location to each of the regional segments can be calculated by Equation (1), where each zip code or regional segment is a F-dimensional vector, [cᵢ, . . . , c_{F}], where, Equation 1:

$${c}_{f} := {\sum }_{w} {r}_{w} c ( {d}_{f} , w )$$

wherein: c(d_{f}, w) represents a shipping rate card, d_{f} is a zone distance from a warehouse location f to each of the one or more regional segments, w is the weight of the one or more products, and r_{w} is a percentage of units in a weight bucket out of a total number of each of the one or more products units shipped. A rate card is a price list of shipping offered by a carrier. A rate card states the unit shipping cost for a given (zone, weight) combination. The zone distance can be a representation of shipping distance. For example, a package shipped within the same city can be a 2-zone shipment, whereas cross-continental shipping can be an 8-zone shipment. Zip codes that are geographically close to each other can have similar characterizations using this set of features. Using shipping costs from the warehouses as features allows the resulting clusters to contain zip codes that are geographically disjointed. For a cost-oriented inventory allocation, these zip codes are homogeneous to the optimization, so the clustering model can be capable of greater demand zone consolidation without compromising shipping cost accuracy.

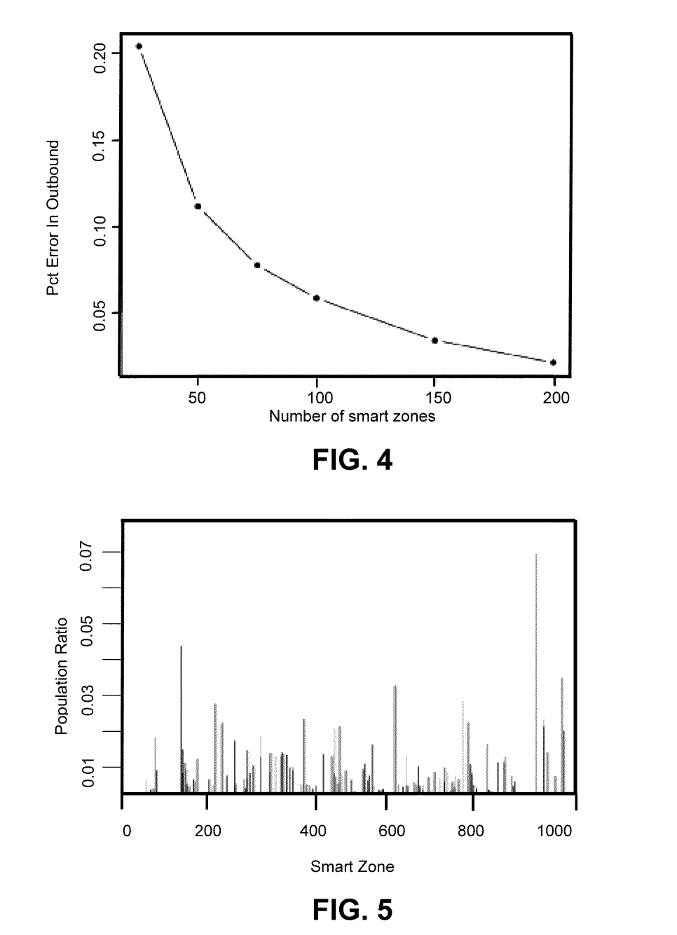

In some embodiments, combining the one or more regional segments into the one or more clusters can include clustering the one or more regional segments into the one or more clusters using a K-medoids method. K-medoids is a more robust version of K-means, which also could be used instead of K-medoids in some embodiments. In several embodiments, the Manhattan distance can be used as a distance metric for the K-medoids method. In some embodiments, a within-cluster-error can be calculated as a percentage error in a unit shipping cost when all of the one or more regional segments within a cluster of the one or more clusters can be represented by a cluster center. In some embodiments, the center of a cluster produced by K-medoids is a real zip code or real regional segment. In some embodiments, a number of clusters of the one or more clusters can be selected when the within-cluster-error is within a minimum or chosen percentage. In some embodiments, the number of clusters is tuned based on shipping cost approximation accuracy. For example, in FIG. 4, the within-cluster errors are plotted against the number of clusters or demand zones. The within-cluster-error can be calculated as the percentage error in the unit shipping cost when all the zip codes within a cluster are represented by the cluster center. The more clusters that are selected or allowed, the less accuracy in warehouse-demand zone shipping cost is lost due to consolidation. In many embodiments, the minimum percentage of the within-cluster-error can be approximately 5 percent (%). When the within-cluster-error is within a certain predetermined percent, for example 5%, the smallest number of clusters that is able to achieve the required minimum percent is denoted by K. For example, in FIG. 4, if the within-error-cluster is chosen to be 5%, the number of clusters or demand zones is approximately K=125. In this example, the more clusters or demand zones, the lower the within-cluster-error. In contrast, with fewer clusters, the within-cluster-error will be a higher percent. In some embodiments, supply chain networks with a higher number of but smaller, distribution centers can require more accuracy, therefore the within-cluster-error minimum percentage can be small in order to increase the number of clusters and decrease errors. In embodiments with a smaller number, but large, distribution centers the within-cluster-error minimum percentage can be higher.

In some embodiments, determining a demand probability distribution across the one or more clusters for the one or more products based on historical data include modeling the demand probability distribution of each of the one or more products as a probability distribution. In some embodiments, the probability distribution can specify a likelihood of a unit demand of each of the one or more products arising from a cluster of the one or more clusters.

In many embodiments, the historical shipping data tensor can be sparse. In addition, the sparseness may not uniform throughout the tensor. The data availability for high velocity products can be greater than the data available low-velocity products. Hence, it can be useful to treat the high-velocity products separately from the low-velocity products. In some embodiments, a high velocity product can be a product of the one or more products having a shipping volume greater than at least 75% of shipping volumes of the one or more products. In some embodiments, a low velocity item can be a product of the one or more products having a shipping volume less than at least 25% of shipping volumes of the one or more products. Focusing on the data tensor for the high-velocity products, the historical shipping data can serve as training observations to provide empirical evidence of the geographical demand distributions. Even for high-velocity products, there can be many missing entries in the shipment data tensor. However, no shipment to a particular location in a given week may not mean zero demand. It could be human error in record keeping, out-of-stock, website interruption, etc. In some embodiments, the demand at various locations for the same product should not be estimated independently because the demand at various locations jointly form the demand probability distribution of the product. Products that are intrinsically related (e.g. products with high affinity associations and products that are variants of the same parent) may have similar demand patterns, which could be utilized to estimate the demand distributions collaboratively. To prevent overfitting the incomplete training data, as well as to take advantage of any underlying correlations among the demand distributions of the products, a Bayesian framework with mixtures of multinomials can be used.

In some embodiments, determining the demand probability distribution of a high velocity product can include using a Dirichlet prior for the product of the one or more products for a time period to determine the demand probability distribution of the product for the time period. For example, in some embodiments, first considering the case of a single SKU and a single time period. The demand distribution of the SKU can be modeled as a probability distribution, β, that specifies the likelihood of a unit demand of SKU i in the network arising from location [symbol] . Then, the set of observed sales quantities of the SKU over all locations can follow a Multinomial distribution with parameters (β_{i,1′}, . . . , β_{i,z}). In order to estimate these unknown parameters given the observations, one approach is to compute a posterior using a Dirichlet-Multinomial framework. Specifically, the likelihood of the observed sales quantities can be Equation 2:

$$P ( {y}_{i} \vert {β}_{i} ) ∝ {\prod }_{z} {β}_{i , z}^{{y}_{i , z}}$$

Typically, a Dirichlet prior is used in combination with the Multinomial likelihood since they are conjugate to each other, i.e. the posterior still has a Dirichlet distribution, making the mean easy to compute. Let the Dirichlet prior be Dir(λ₁, . . . , λ_{z}, where the sum Σ_{z}λ_{z} represents the strength of the prior, then Equation 3 becomes:

$$P ( {β}_{i} \vert λ ) ∝ {\prod }_{z} {β}_{i , z}^{{λ}_{z} - 1}$$

The posterior then attains a form of Equation 4:

P(βᵢ|y_{i,}λ)˜Dir(Δ₁+y_{i,1}, . . . , λ_{i,z})

In this case, the Dirichlet prior acts like pseudo-counts and has a smoothing effect as it would assign a non-zero percentage for location z even if y_{i,z}=0.

Choosing a useful prior can be application-specific. In several embodiments the population distribution over the regional segments can be used as the Dirichlet prior. The prior can reflect a general demand distribution over the locations for a generic item. In many instances, population distribution can be useful as the prior because population size can be a driving factor for product demand. For example, the population data from US Census can be aggregated by the demand zones or clusters. FIG. 5 illustrates a bar plot of population distribution over the demand zones or clusters represented by their three-digit zip codes in the center of the clusters.

In some embodiments, the Dirichlet-Multinomial approach can be used to compute the posterior demand probability distributions for each SKU and each time period. However, the distribution for each SKU is estimated independently, and no cross-SKU information is taken advantage of. For popular or high velocity items, there can be abundant sales data for most or all locations. Therefore, estimating independently may still work well.

However, in some embodiments, determining the demand probability distribution for an item, such as a high velocity item without abundant sales data for most or all locations, can include assigning a product to a product cluster, maximizing the distribution of the product cluster, and calculating a probability of assigning the product to the product cluster given historical data. For many items, the scarcity of data may have an impact on the estimation results. In some instances, many items may exhibit similar demand probability patterns due to similar usage or high affinity. In those cases, taking correlation among similar items into account can improve the estimation results.

In some embodiments, a more collaborative approach can be to learn the demand probability distributions at a cluster level, where the clusters are built on demand probability distribution similarity. For example, in some embodiments, a probabilistic approach in assigning cluster membership for each SKU can be used so that its demand probability distribution is a convex combination of cluster distributions. In some embodiments, cluster-level demand probability distributions can be estimated more reliably because of the availability of training data. In addition, the probabilistic membership assignment tends to smooth out the impulsive errors in low velocity items.

Specifically, basic modeling of SKU-level demand probability distribution can be extended by a single Multinomial to a mixture of Multinomials. A new parameter vector α, which can specify the marginal cluster membership probabilities for a generic SKU. The SKU clusters can then be indexed by g. The likelihood for a SKU i placed in cluster membership is thus Equation 5:

$$P ( {y}_{i} \vert α , β ) ∝ {\sum }_{g} {α}_{g} {\prod }_{z} {β}_{g , z}^{{y}_{i , z}}$$

In some embodiments, a non-informative prior λα can be used on α and the Dirichlet prior based on population ratio can be used on β. In this case, the latent variable is the cluster label for each SKU. In order to make the parameter estimation tractable, it can be assumed that all SKUs are independent. Hence, the catalog likelihood is given by Equation 6:

$$P ( Y \vert α , β ) ∝ {\prod }_{i} P ( {y}_{i} \vert α , β )$$

The posterior is then Equation 7:

p(α,β|Y)∝P(Y|α,β)p(α)p(β)

and then Equation 8:

$$p ( α , β \vert Y ) ∝ P ( Y \vert α , β ) p ( α ) p ( β ) ∝ ( {\prod }_{i} {\sum }_{g} ( {\prod }_{z} {β}_{g , z}^{{y}_{i , z}} ) ) {\prod }_{g} {α}_{g}^{{λ}_{α} - 1} {\prod }_{g} {\prod }_{z} {β}_{g , z}^{{λ}_{β} - 1}$$

In some embodiments, to compute a maximum-aposteriori (MAP) estimate of the parameters α and β, the posterior in Equation 8 can be maximized. In some embodiments, one common approach is to use the expectation-maximization (EM) algorithm to find a local maximum of the highly nonlinear (non-convex) optimization problem as shown in Equation 9:

$${max}_{α , β} p ( α , β \vert Y )$$

In some embodiments, the EM algorithm is suitable for finding an approximate MAP when a latent variable is involved. In some embodiments, the unknown latent variable is the cluster membership of each SKU. Each iteration of the EM algorithm can be a two-step procedure that alternatingly constructs the expected posterior conditional on the augmented set of parameters (including the latent variables) and computes the maximizer for the resulting expectation. In some embodiments, the EM algorithm can be stopped when the log likelihood becomes stabilized. The steps of each EM iteration for mixture of Multinomials admit analytical forms for determining the probability, γ_{i,g}, that assignment for SKU i to cluster g given historical data and an estimate of α and β, as shown in Equation 10, wherein P(Tᵢ=g|Y; α′,β′) is the identity of the cluster that SKU i is assigned:

$${γ}_{i , g} = P ( {T}_{i} = g \vert Y ; {α}^{′} , {β}^{′} ) = \frac{{a}_{g}^{′} {{Π}_{z} ( {β}_{gz}^{′} )}^{{y}_{i , z}}}{{\sum }_{{g}^{′}} {α}_{g}^{′} {{Π}_{z} ( {β}_{gz}^{′} )}^{{y}_{i , z}}} \\ {α}_{g} ∝ {λ}_{a} - 1 + {\sum }_{i} {γ}_{i , g} \qquad Equation 11$$

and Equation 12 can show the probability that SKU i is assigned to cluster g and the probability distribution β_{g,z} at the cluster:

$${β}_{g , z} ∝ {λ}_{β} - 1 + {\sum }_{i} {y}_{i , g}$$

Equations 11 and 12 can be normalized over g and z respectively. The individual distribution can then be computed from the posterior membership probabilities by Equation 13 to determine the demand probability distribution at the cluster g:

$${β}_{i , z} = {\sum }_{g} {γ}_{i , g} {β}_{g , z}$$

In some embodiments, to capture time-variation of demand distribution empirically, the results from the mixture of Multinomials can be used as a strong prior to estimate the time-dependent distributions through the Dirichlet-Multinomial framework. In many embodiments, a 26 week time frame can be estimated. In some embodiments, the time frame chosen can be representative of seasons or holidays. In other embodiments, other time frame windows can be chosen.

For the low velocity items, the available training data is often too scarce to make any meaningful estimations, and the variance in the results can be high. In some embodiments, low velocity items constitute more than 70% (in terms of SKU count) of the catalog. In this case, the data has been aggregated at category level with each SKU belonging to a single category. In some embodiments, a Dirichlet-Multinomial model, such as a Dirichlet-Multinomial similar to Equation 4, can be used to estimate the category-level demand distributions.

In some embodiments, the demand probability distribution framework can be trained on historical shipping data and the learned demand probability distributions can be tested on new data in a corresponding time period. In many embodiments, the ground truth demand probability distributions can be unknown and the current data can be a different realization of the underlying distributions, therefore, exact estimation errors can be difficult to compute. For example, a data set containing historical online order shipping records for Walmart.com can be used as training data. In this example, each record specifies the shipping date, SKU identification, package identification, quantity in units, origin warehouse identification, and destination zip code. From this data, the three-dimensional training and test data sets can be constructed.

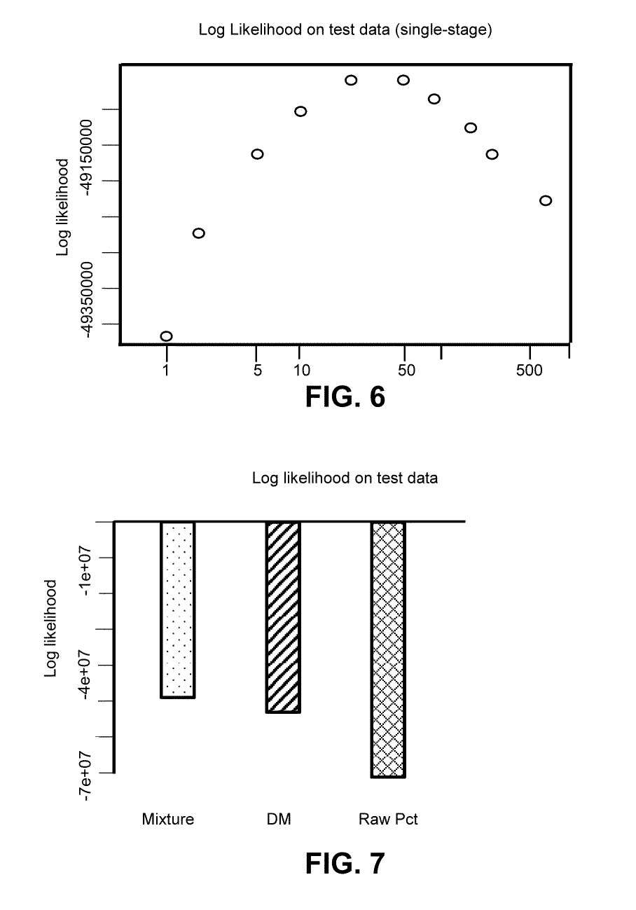

In many embodiments, a number of product clusters or mixtures G can be chosen. In some embodiments, Dirichlet-Multinomial model such as the Dirichlet-Multinomial of Equation 4, can be a special instance of mixture of Multinomials with the number of mixtures G equaling a number N and each SKU assigned deterministically to a cluster of itself. In an embodiment, the range of numbers N can be from 1 to 500. The resulting log-likelihoods of the test data are plotted in FIG. 6. In some embodiments, a peak number of product clusters can be chosen. In FIG. 6, the chosen number of product clusters is G=50. In this example, 50 prototypical mixtures can be defined. In some embodiments, these mixtures can be constructed using prototypical items, but may not correspond to real world items or mixtures. In other embodiments, the mixtures can be constructed using historical data. In some embodiments, each SKU assignment to mixture (G) can be soft-assignment probability. In some embodiments, the demand distribution is a weighted average of clusters, wherein the weights correspond to the soft-assignment probability. In other embodiments, more mixtures (G) can be chosen, for example, when expanding into a new market. In some embodiments, large retails can use a higher mixture (G). In many embodiments, mixture (G) can be in the range of 10-100. In some embodiments, when the number of warehouses or distribution centers is low, the number of mixtures (G) can be low.

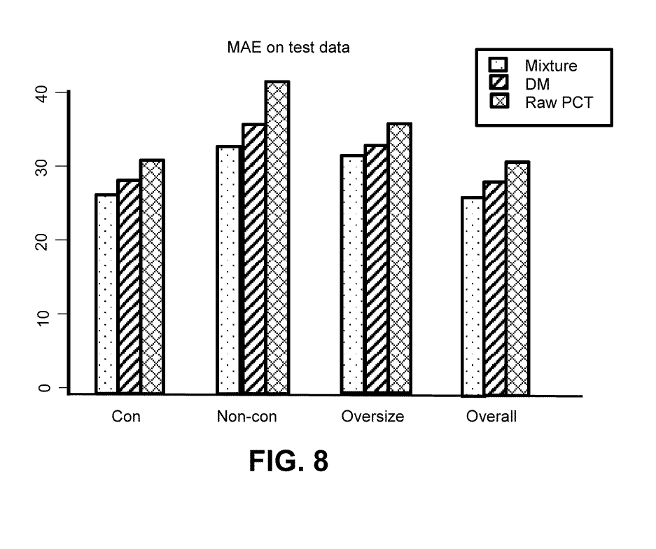

FIG. 7 illustrates a log likelihood comparison of the mixture of Multinomials demand probability distribution with two benchmark methods, (1) a Dirichlet-Multinomial model, such as that of Equation 2, and (2) raw demand percentages based on historical data. FIG. 8 illustrates a mean absolute error (MAE) of the comparisons. The test log likelihood is defined as Equation 14:

$$P ( \tilde{Y} \vert \tilde{β} ) ∝ log {\sum }_{i} {\sum }_{z} {\tilde{β}}_{i , z}^{{\tilde{y}}_{i , z}}$$

Where \tilde{Y} is the test shipping data, \tilde{β} is the estimated distributions, and the MAE is for each item and time period. Note that the raw distributions contain 0% for certain combinations of (SKU, time, location), which would result in a −∞ test log likelihood. In some embodiments, a small e to avoid the degeneracy can be added. In some embodiments, the Bayesian approaches improved both test log likelihood and MAE. In FIG. 8, the MAE's were computed for each of the three product types (conveyable, non-conveyable, and over-size) as well as overall. In some embodiments, the improvement in MAE was most tangible for non-conveyable and oversize SKUs, which have less training data then conveyable SKUs.

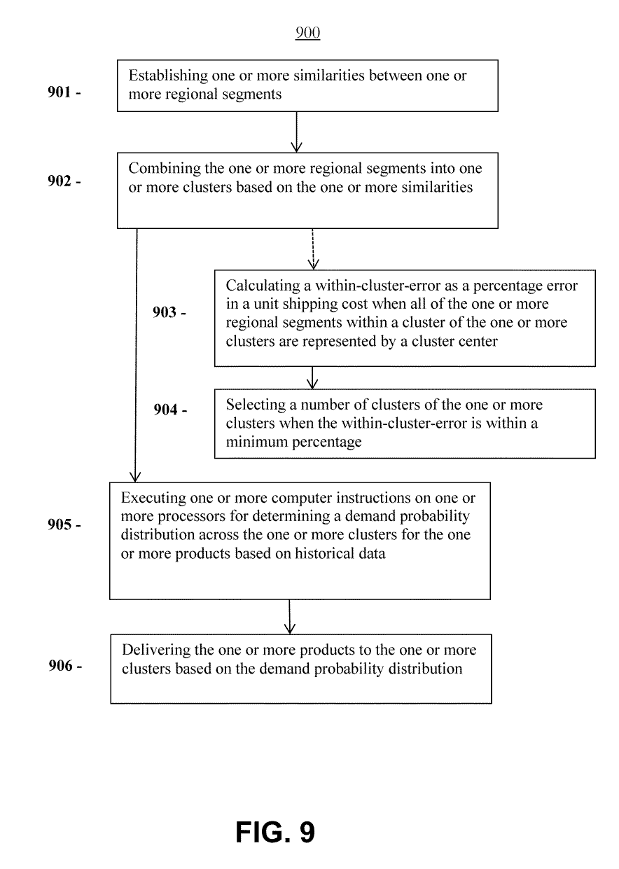

Turning ahead in the drawings, FIG. 9 illustrates a flow chart for a method 900 of estimating demand according to an embodiment. In some embodiments, method 900 can be a method for computing a demand estimate for one or more products in a demand network. The demand network can be identical or similar a demand network established by customers 350 and 351 (FIG. 3). Method 900 is merely exemplary and is not limited to the embodiments presented herein. Method 900 can be employed in many different embodiments or examples not specifically depicted or described herein. In some embodiments, the procedures, the processes, and/or the activities of method 900 can be performed in the order presented. In other embodiments, the procedures, the processes, and/or the activities of method 900 can be performed in any suitable order. In still other embodiments, one or more of the procedures, the processes, and/or the activities of method 900 can be combined or skipped. In some embodiments, method 900 can be implemented at least partially by demand estimating system 370 (FIG. 3).

Method 900 can include a block 901 of establishing one or more similarities between one or more regional segments. In some embodiments, the one or more regional segments can be three digit zip codes of the United States. In a number of embodiments, establishing the one or more similarities between the one or more regional segments can include representing each of the one or more regional segments by an average shipping cost for each of the one or more products from a location to each of the one or more regional segments and weighting the average shipping cost by a total shipping volume for each of the one or more regional segments. In some embodiments, the average shipping cost for each of the one or more products from the location to each of the regional segments is calculated by Equation (1):

$${c}_{f} := {\sum }_{w} {r}_{w} c ( {d}_{f} , w )$$

wherein: c(d_{f}, w) represents a shipping rate card, d_{f} is a zone distance from a warehouse location f to each of the one or more regional segments, w is the weight of the one or more products, and r_{w} is a percentage of units in a weight bucket out of a total number of each of the one or more products units shipped.

In many embodiments, method 900 also can include a block 902 of combining the one or more regional segments into one or more clusters based on the one or more similarities. In some embodiments, combining the one or more regional segments into the one or more clusters can include clustering the one or more regional segments into the one or more clusters using a K-medoids method. In several embodiments, the Manhattan distance can be used as a distance metric for the K-medoids method.

In some embodiments, block 902 can include optional sub-block 903 of calculating a within-cluster-error as a percentage error in a unit shipping cost when all of the one or more regional segments within a cluster of the one or more clusters can be represented by a cluster center. In some embodiments, block 902 also can include sub-block 904 of selecting a number of clusters of the one or more clusters when the within-cluster-error is within a minimum percentage. In many embodiments, the minimum percentage of the within-cluster-error can be approximately 5 percent.

In some embodiments, after block 902, method 900 can include a block 905 of executing one or more computer instructions on one or more processors for determining a demand probability distribution across the one or more clusters for the one or more products based on historical data. In some embodiments, one or more of blocks 901 or 902, and one or more of sub-blocks 903 or 904, also can be performed by executing one or more computer instructions on one or more of the same or different processors.

In several embodiments, determining the demand probability distribution can include modeling the demand probability distribution of each of the one or more products as a probability distribution. In some embodiments, the probability distribution can specify a likelihood of a unit demand of each of the one or more products arising from a cluster of the one or more clusters.

In some embodiments, a high velocity product can be a product of the one or more products having a shipping volume greater than at least 75% of shipping volumes of the one or more products. In some embodiments, determining the demand probability distribution of a high velocity product can include using a Dirichlet prior for the product of the one or more products for a time period to determine the demand estimation or demand probability distribution of the product for the time period. In several embodiments the population distribution over the regional segments can be used as the Dirichlet prior. In some embodiments, a low velocity item can be a product of the one or more products having a shipping volume less than at least 25% of shipping volumes of the one or more products. In some embodiments, determining the demand probability distribution for a low velocity item can include assigning a product to a product cluster, maximizing the distribution of the product cluster, and calculating a probability of assigning the product to the product cluster given historical data.

In several embodiments, method 900 can further include a block 906 of delivering the one or more products to the one or more clusters based on the demand probability distribution.

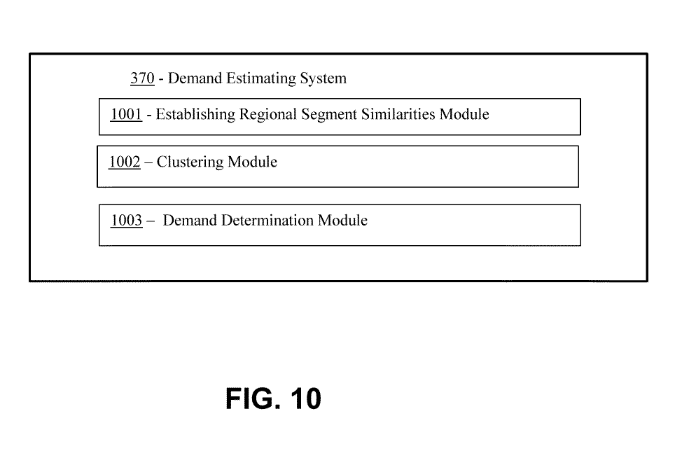

Turning ahead in the drawings, FIG. 10 illustrates a block diagram of demand estimating system 370, according to the embodiment shown in FIG. 3. Demand estimating system 370 is merely exemplary and is not limited to the embodiments presented herein. Demand estimating system 370 can be employed in many different embodiments or examples not specifically depicted or described herein. In some embodiments, certain elements or modules of demand estimating system 370 can perform various procedures, processes, and/or acts. In other embodiments, the procedures, processes, and/or acts can be performed by other suitable elements or modules.

In a number of embodiments, demand estimating system 370 can include an establishing regional segment similarities module 1001. In certain embodiments, establishing regional segment similarities module 1001 can perform block 901 (FIG. 9) of establishing similarities between one or more regional segments. In some embodiments, demand estimating system 370 can include a clustering module 1002. In certain embodiments, clustering module 1002 can perform block 902 (FIG. 9) of combining the one or more regional segments into one or more clusters based on the one or more similarities.

In various embodiments, demand estimating system 370 can include a demand estimating module 1003. In certain embodiments, demand estimating module 1003 can perform block 905 (FIG. 9) of executing one or more computer instructions on one or more processors for determining a demand probability distribution across the one or more clusters for the one or more products based on historical data.

Although estimating demand has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-10 may be modified, and that the foregoing discussion of certain of these embodiments does not necessarily represent a complete description of all possible embodiments. For example, one or more of the procedures, processes, activities, or modules of FIGS. 9 and 10 may include different procedures, processes, and/or activities and be performed by many different modules, in many different orders. As another example, the modules within demand estimating system 370 in FIG. 10 can be interchanged or otherwise modified.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for computing a demand probability for one or more products, comprising:
establishing one or more similarities between one or more regional segments;
combining the one or more regional segments into one or more clusters based on the one or more similarities;
executing one or more computer instructions on one or more processors for determining a demand probability distribution across the one or more clusters for the one or more products based on historical data;
and
delivering the one or more products to the one or more clusters based at least in part on the demand probability distribution.

2. The method of claim 1, further comprising:
providing three digit zip codes for the one or more regional segments.

3. The method of claim 1, wherein:
establishing the one or more similarities between the one or more regional segments comprises:
representing each of the one or more regional segments by an average shipping cost for each of the one or more products from a location to each of the one or more regional segments;
and
weighting the average shipping cost by a total shipping volume for each of the one or more regional segments.

4. The method of claim 3, further comprising:
calculating the average shipping cost for each of the one or more products from the location to each of the regional segments as:
c_{f}:=Σ_{w}r_{w}c(d_{f},w)
wherein:
c(d_{f}, w) represents a shipping rate card;
d_{f} is a zone distance from a warehouse location f to each of the one or more regional segments;
w is the weight of the one or more products;
and
r_{w} is a percentage of units in a weight bucket out of a total number of each of the one or more products units shipped;

5. The method of claim 1, wherein:
combining the one or more regional segments into the one or more clusters comprises clustering the one or more regional segments into the one or more clusters using a K-medoids method.

6. The method of claim 5, wherein:
clustering the one or more regional segments into the one or more clusters using the K-medoids method, further comprises:
using Manhattan distance as a distance metric for the K-medoids method.

7. The method of claim 5, further comprising:
calculating a within-cluster-error as a percentage error in a unit shipping cost when all of the one or more regional segments within a cluster of the one or more clusters are represented by a cluster center;
and
selecting a number of clusters of the one or more clusters when the within-cluster-error is within a minimum percentage.

8. The method of claim 7, further comprising:
providing approximately 5 percent as the minimum percentage of the within-cluster-error.

9. The method of claim 5, wherein:
determining the demand probability distribution comprises:
modeling the demand probability distribution of each of the one or more products as a probability distribution, wherein the probability distribution specifies a likelihood of a unit demand of each of the one or more products arising from a cluster of the one or more clusters.

10. The method of claim 9, wherein:
for a product of the one or more products having a shipping volume greater than at least 75% of shipping volumes of the one or more products, determining the demand probability distribution comprises using a Dirichlet prior for the product of the one or more products for a time period to determine the demand probability distribution of the product for the time period;
and
for a product of the one or more products having a shipping volume less than at least 25% of shipping volumes of the one or more products, determining the demand probability distribution comprises:
assigning a product to a product cluster;
maximizing the distribution of the product cluster;
and
calculating a probability of assigning the product to the product cluster given historical data.

11. The method of claim 10, further comprising:
providing a population distribution over the regional segments for the Dirichlet prior

12. A system for computing a demand probability for one or more products, comprising:
one or more processing modules;
and
one or more non-transitory memory storage modules storing computer instructions configured to run on the one or more processing modules and to perform acts of:
establishing one or more similarities between one or more regional segments;
combining the one or more regional segments into one or more clusters based on the one or more similarities;
and
determining a demand probability distribution across the one or more clusters for the one or more products based on historical data.

13. The system of claim 12, wherein:
wherein the regional segments comprise three digit zip codes.

14. The system of claim 12, wherein:
establishing the one or more similarities between the one or more regional segments comprises:
representing each of the one or more regional segments by an average shipping cost for each of the one or more products from a location to each of the one or more regional segments;
and
weighting the average shipping cost by a total shipping volume for each of the one or more regional segments.

15. The system of claim 14, wherein:
wherein the average shipping cost for each of the one or more products from the location to each of the regional segments is calculated by:
c_{f}:=Σ_{w}r_{w}c(d_{f},w)
wherein:
c(d_{f}, w) represents a shipping rate card;
d_{f} is a zone distance from a warehouse location f to each of the one or more regional segments;
w is the weight of the one or more products;
and
r_{w} is a percentage of units in a weight bucket out of a total number of each of the one or more products units shipped.

16. The system of claim 12, wherein:
combining the one or more regional segments into the one or more clusters comprises clustering the one or more regional segments into the one or more clusters using a K-medoids method.

17. The system of claim 16, wherein:
clustering the one or more regional segments into the one or more clusters using the K-medoids method, further comprises:
using Manhattan distance as a distance metric for the K-medoids method.

18. The system of claim 16, wherein:
the one or more non-transitory memory storage modules storing the computer instructions configured to run on the one or more processing modules and to perform additional acts of:
calculating a within-cluster-error as a percentage error in a unit shipping cost when all of the one or more regional segments within a cluster of the one or more clusters are represented by a cluster center;
and
selecting a number of clusters of the one or more clusters when the within-cluster-error is within a minimum percentage.

19. The system of claim 18, wherein:
the minimum percentage of the within-cluster-error is approximately 5 percent.

20. The system of claim 16, wherein:
determining the demand probability distribution comprises:
modeling the demand probability distribution of each of the one or more products as a probability distribution, wherein the probability distribution specifies a likelihood of a unit demand of each of the one or more products arising from a cluster of the one or more clusters.

21. The method of claim 20, further wherein:
for a product of the one or more products having a shipping volume greater than at least 75% of shipping volumes of the one or more products, determining the demand probability distribution comprises:
using a Dirichlet prior for the product of the one or more products for a time period to determine the demand probability distribution of the product for the time period;
assigning a product to a product cluster;
maximizing the distribution of the product cluster;
and
calculating a probability of assigning the product to the product cluster given historical data.
and
for a product of the one or more products having a shipping volume less than at least 25% of shipping volumes of the one or more products, determining the demand probability distribution comprises:
assigning a product to a product category;
and
maximizing the distribution of the product category;

22. The method of claim 21, wherein:
the number of product clusters is approximately 50.
